(19) United States
(12) Patent Application Publication
(10) Pub. No.: US 2006/0259357 A1
(43) Pub. Date: Nov. 16, 2006

(54) Intelligent dynamic market data collection and advertising delivery system

(76) Inventor: Fu-Sheng Chiu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/127,150

(22) Filed: May 12, 2005

(51) Int. Cl. G06Q 30/00

(52) U.S. Cl. 705/14

(57) ABSTRACT

An intelligent dynamic market data collection system which accurately and effectively targets appropriate users based on the collected market data. After collecting or analyzing the market data, appropriate advertisements or other marketing materials are sent to individual users. The market data collection and advertising delivery can be continuously, automatically, scheduled, or periodically updated or sent. The system is capable of collecting and analyzing a wide variety of data. Among the data are, for example, Internet Protocol (IP) number, user history, voting history, viewing history, scheduling history, rating history, purchasing history, current web page, web browsing history, current program identification, and user account information. Since a user's IP indicates their location, regional advertising is easily accomplished. Therefore, only appropriate advertising is sent to users thereby resulting in increased effectiveness.

### BACKGROUND OF THE INVENTION

1. Field of the Invention

The present invention relates to a data collection system. More specifically, the present invention discloses an intelligent dynamic market data collection and advertising delivery system which allows marketers to more accurately target prospective clients by utilizing the collected data to deliver appropriate advertising to appropriate users.

2. Description of the Prior Art

Conventional marketing consists mainly of print media or television advertising. Marketing in print media is made up of full or partial page advertisements. Television advertising consists of commercials of varying length.

While print media such as magazines tend to focus on a specific subject, the breadth of the subject or the variety of readers does not allow print advertising to be very effective. For example, a computer magazine may focus on computers but this topic is so broad as to encompass hardware, software, application of systems, networks, ergonomics, etc. Advertising aimed at one of these areas is ignored by readers not interesting in that particular aspect of computers. Additionally, readers of different demographics avoid advertising that isn't aimed at their demographic group.

Also, readers of print tend to only read the copy once, so advertisers are limited to one chance to get the readers attention. Failing to grab the reader's attention results in lost opportunities and wasted money.

Television commercials are placed between program segments during broadcast. The length of the commercials can be selected according to need or budget. However, due to splitting of the program, many viewers tend to ignore these advertisements or use this time to take a break from viewing.

As described, conventional advertising is inefficient since it cannot target appropriate users and has a low chance for success since it is usually seen once or not at all.

Therefore, there is need for an intelligent and dynamic market data collection system that allows marketers to accurately target potential customers based on the collected data and deliver appropriate advertising to appropriate users.

### SUMMARY OF THE INVENTION

To achieve these and other advantages and in order to overcome the disadvantages of the conventional method in accordance with the purpose of the invention as embodied and broadly described herein, the present invention provides a market data collection system that accurately and effectively targets potential customers by collecting market data of users and then intelligently and dynamically provides appropriate marketing materials to appropriate users.

The intelligent dynamic market data collection system of the present invention capitalizes on the interaction, interest, and habits of the users. Additionally, user's history and account information can be used as market data. Moreover, the user's location is used to provide data.

Utilizing the collected data, marketers can accurately target specific users depending on different criteria. For example, using a user's IP address indicates the location of the user. Therefore, if the user is in, for example, California, only advertising pertinent to California residents would be sent to the user.

Moreover, since the system of the present invention can access, collect, and analyze the data, the advertising can be sent or updated in an intelligent and dynamic manner.

The present invention is utilized in an intelligent interactive multimedia system that provides a wide variety of multimedia content and services to a plurality of users utilizing various platforms. For example, users can utilize the Internet, satellite television, cable television, television equipped with set top boxes, telecom network, wireless, cellular phone, local area network, or other electronic equipment connected to other types of networks.

The system allows users to not only enjoy the multimedia content, but also interact with the multimedia content, thereby increasing the participant's level of enjoyment and satisfaction. As a result users are more likely to participate more frequently and for longer periods of time.

Multiple video and audio signals are streamed in real time or near real time and as a result, a single display or window can allow users to conveniently interact with these multiple multimedia signals. Content providers or producers can utilize interactive applications, for example, when a content producer provides multimedia content, users can interact with the multimedia content and with other users in real-time.

Channels with specific content or themes such as movies, education, meetings, conferences, and concerts can be provided to users. Channels can be grouped by theme or area of interest. Users or a group of users can participate in interactive multimedia sessions and communicate by text messaging, audio, or video signals in real time or near real time. Furthermore, numerous interactions such as application sharing, synchronized internet browsing, file distribution and sharing, voting and polling, session recording, shared whiteboard, and chat room are provided.

The intelligent dynamic market data collection and advertising delivery system of the present invention accurately and effectively targets appropriate users based on the collected market data. After collecting or analyzing the market data, appropriate advertisements or other marketing materials are sent to individual users. The market data collection and advertising delivery can be continuously, automatically, scheduled, or periodically, updated or sent. The system is capable of collecting and analyzing a wide variety of data. Among the data are, for example, Internet Protocol (IP) number, user history, voting history, viewing history, scheduling history, rating history, purchasing history, current web page, web browsing history, current program identification, and user account information. Since a user's IP indicates their location, regional advertising is easily accomplished. Therefore, only appropriate advertising is sent to users thereby resulting in increased effectiveness.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1 and 2 are flowcharts illustrating an intelligent dynamic market data collection and advertising delivery system according to an embodiment of the present invention;

FIGS. 3 and 4 illustrate interactive multimedia interfaces and displays incorporating the intelligent dynamic market data collection and advertising delivery system of the present invention; and

FIG. 5 is a diagram illustrating the infrastructure of an interactive multimedia system utilized by the intelligent dynamic market data collection and advertising delivery system according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The intelligent dynamic market data collection system of the present invention accurately and effectively targets appropriate users based on the collected market data. After collecting or analyzing the market data, the marketer can send an appropriate advertisement or other marketing materials to individual users. Since a computer system and network is utilized, the information collection and analyzing are fast and can be accomplished dynamically. The market data can be continuously updated or scheduled. For example, the market data and advertising delivery can be scheduled to occur periodically or when a program changes. Additionally, when a user logs into the multimedia system, the data collection system can be notified and begin processing and delivering.

The system is capable of collecting and analyzing a wide variety of data. Among the data are, for example, Internet Protocol (IP) number, user history, voting history, viewing history, scheduling history, rating history, current program identification, and user account information.

An IP is a unique number consisting of 4 parts separated by dots, for example, 203.69.68.101. Since every machine that is connected to the Internet has a unique IP number, examination of the number will identify the user or user's location.

A portion of the IP indicates the user's country or region location. Utilizing this location indication, advertising that only applies to a specific area will be sent to users in that region. Additionally, IP ranges can be set so that any IP falling into the range will receive the advertising.

When a user participates in voting, the history of their voting can be recorded. For example, if a user votes on a poll asking for their favorite hobby, how they answered can affect what advertising they see. For example, if they responded with basketball, an advertisement for a basketball jersey can appear to that user. Users that voted differently will receive advertisements appropriate with their responses.

A user's viewing history can also be recorded and analyzed. For example, if a user routinely watches music concerts, advertisements for music for download or music CD's can be shown. Similarly, a user's scheduling history can be recorded and analyzed.

During or after a program, users are allowed to rate the multimedia content. This rating history can also be recorded and analyzed. Additionally, the current program or channel can be identified and analyzed.

A user can purchase items advertised during the program. The purchasing history of the user can be recorded and collected for analyzing.

Furthermore, when a user signs up for the multimedia service, they are required to provide certain information. This information can comprise, for example, gender, age, location, job title, hobbies, name, etc. By collecting and analyzing this information or parts of this information, intelligent marketing materials can be sent to appropriate users and not sent to inappropriate users.

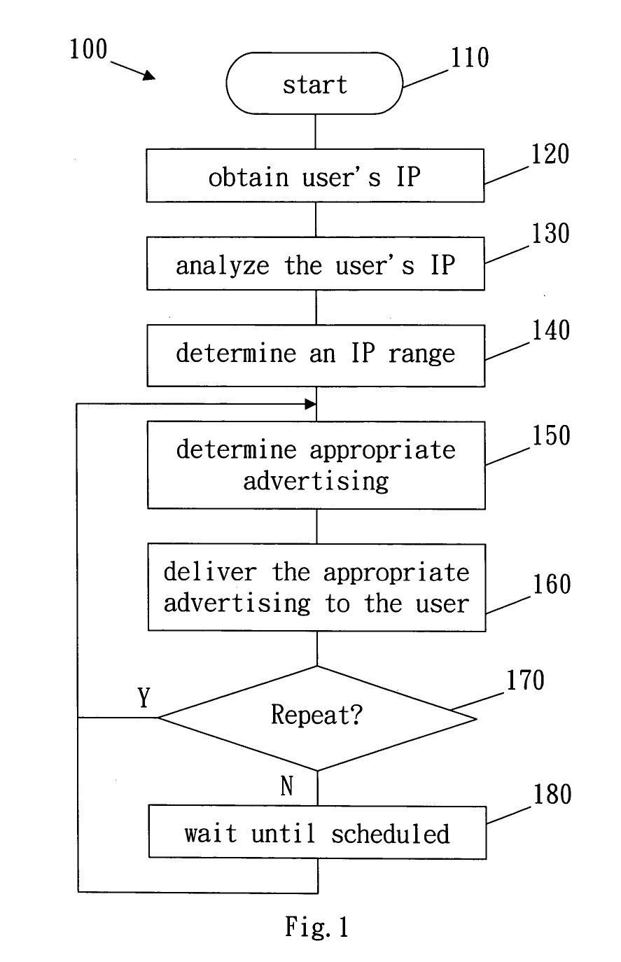

Refer to FIG. 1, which is a flowchart illustrating an intelligent dynamic market data collection and advertising delivery system according to an embodiment of the present invention.

As shown in FIG. 1, the system 100 starts at step 110 and in step 120 obtains the user's internet protocol (IP) number. Then the user's IP is analyzed in step 130 and an IP range is determined in which the user's IP falls into in step 140. Next, appropriate advertising based on the IP range is determined in step 150. The requirements to determine the appropriate advertising can be stored in a database.

After determining the appropriate advertising, the advertising is delivered to the user in step 160. If the advertising is continuously updated, in step 170, the system returns to step 150. If the advertising is scheduled, in step 180 the system waits until the next scheduled update before returning to step 150.

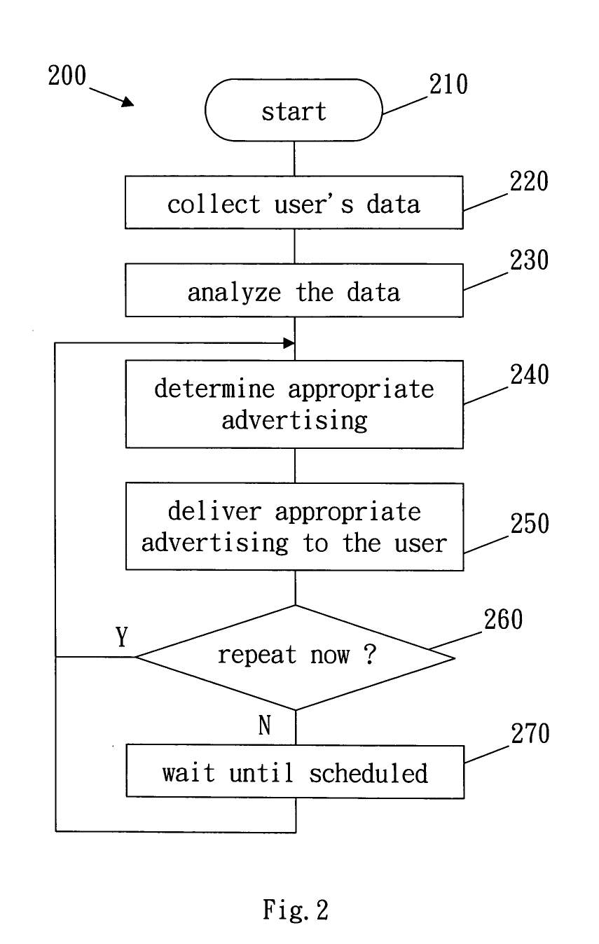

Refer to FIG. 2, which is a flowchart illustrating an intelligent dynamic market data collection and advertising delivery system according to an embodiment of the present invention.

The embodiment illustrated in FIG. 2 is similar to FIG. 1. However, in this embodiment the system has greater breadth and depth. The system 200 starts in step 210 and collects user data in step 220. The user's data can comprise user history, voting history, viewing history, scheduling history, rating history, purchasing history, current web page, web history, current program identification, account information, IP, or a combination of these. The account information can comprise gender, age, location, job title, hobbies, interests, and name.

In Step 230 the data is analyzed and in step 240 appropriate advertising is determined based on the data. Next, in step 250, the appropriate advertising is delivered to the user. If the advertising is to be continuously updated, in step 260 the system returns to step 240. If the advertising is periodically or scheduled for update, the system will wait in step 270 until ready and then return to step 240.

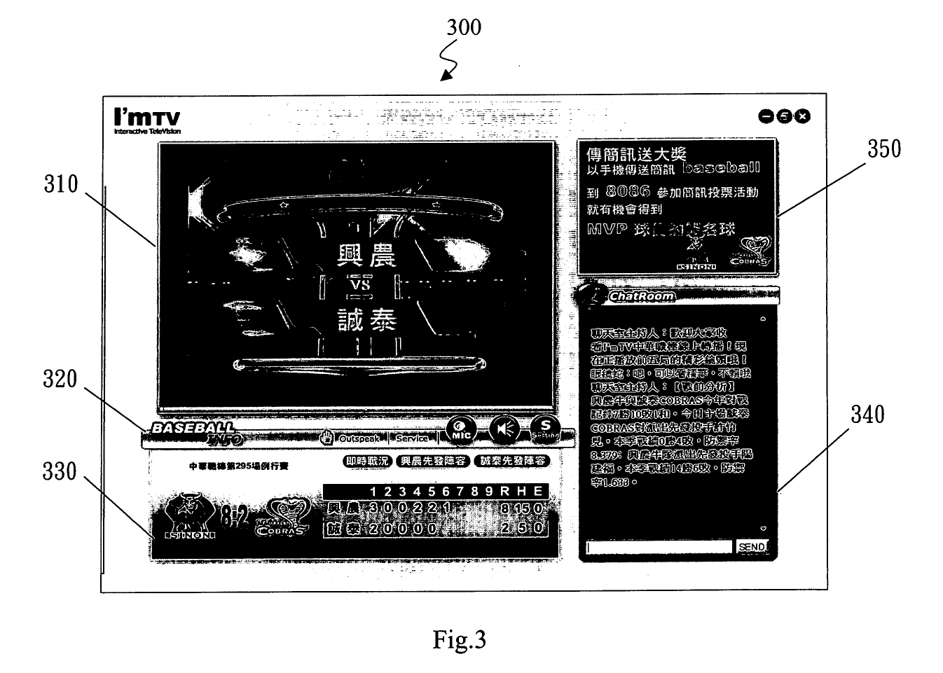

Refer to FIG. 3, which illustrates an interactive multimedia interface and display incorporating the market data collection system of the present invention.

As shown in the FIG. 3, the interactive multimedia interface 300 comprises a multimedia window 310, a command bar 320, an information window 330, a chat room area 340, and an advertising window 350.

As an example of an application, FIG. 3 illustrates a baseball channel. The multimedia window 310 displays the live or pre-recorded action of the baseball game. Additionally, the multimedia window can be resized to full-screen for maximum viewing size.

Statistics or other information is provided in the information window 330. The information in this example comprises the scoring, team statistics, or individual player statistics. Display selection buttons allow the user to easily select which view they want. Additionally, each element in the information can be scrolled through or clicked to select.

A chat room area 340 allows members to communicate via text messages. A member can type their message into the text input box. When they are finished composing their message they press the send button and the message will be displayed in the message window of the chat room 340. The contents of the message window can be scrolled through utilizing the scroll bar.

The advertising window 350 allows the content provider or producer to provide appropriate advertising to users. In this baseball example, the appropriate advertising could be for products related to baseball. More specifically, depending upon the collected data such as location, products related to a particular user's preferences or history can be displayed.

Other areas, histories, habits, or preferences of a user can be obtained by the following interactive tools.

A voting or polling area is provided so that the host or users can create a poll and the participants can vote. The poll can be created manually or automatically from a questionnaire of file. Once voting begins, the system can provide the results to only the host or show the results to everyone. Additionally, the results can be updated and displayed in real time during the voting, or can be tallied and displayed after voting is over.

Also, this voting area can be used as a question and answer system. For example, on an educational channel the host or instructor can pose a question and each user or student can respond with their answer. The answers can be formulated in multiple choice, essay, fill in the blank, etc. formats. The percentage or number of users selecting each answer can be displayed during the answering or after everyone has answered. The user names of the participants selecting the correct response can also be displayed if desired.

Additionally, the voting or answer history can be kept for individual participants. For example, a series of questions can be posed as a test by the instructor and the test results for individual users can be obtained. Similarly in a voting application, the voting history or behaviour can be recorded for future application or review.

A chat room area is provided for allowing users to use a chat room or chat area to communicate with other online users. A messaging area is provided for allowing users to communicate directly with a particular user without all other users observing the communication. For example, user A and user B can send text messages back and forth to each other without the other users being aware of or privilege to their conversation. However, the host has the ability to monitor the messaging if desired. It should be noted that the chat room area and messaging area can be the same area or separate areas.

For commercial content producers or providers an advertising area or window is provided. Content producers or providers can periodically or continuously display advertising or notices. The revenue earned by this advertising can be used to offset the cost of producing the interactive multimedia content.

Additionally, the voting area and advertising area can work together so that users can vote in regards to the advertised product or products. Alternatively, advertisements can be selected based on voting results. For example, if a poll asks for a user's favorite hobby and the user votes for sports, an advertisement regarding sports can be displayed.

A channel guide is provided for displaying a program or channel guide to allow users to select between channels, obtain channel information, scheduling, etc. The channel guide works together with the scheduler module so that users can easily schedule recording or notification of upcoming events. The channel guide can group and display channels by multimedia type, content, area, location, interest, popularity, date, etc. In this way, users can, for example, quickly find content in their area of interest or shortly upcoming events.

To assist users in remembering times or schedules of live or pre-recorded content, a scheduler is provided. The scheduler allows users to establish a recording schedule for future sessions or occurrences. For example, if a live concert will be broadcast at a certain time or date, the user can enter the information in the scheduler and the concert will be recorded regardless if the user is present at the broadcast time.

Additionally, the scheduler can act as a timer or alarm which will give the user a notice or reminder when a session is approaching. For example, if a network meeting session will occur on a certain date, the scheduler will give the user notices at selected intervals to prepare the user for the session. The scheduler history can be recorded for the collection system to analyze.

A purchase area allows users to quickly and easily purchase multimedia content or products presented on a channel. For example, a user can purchase a movie or concert video while watching or after watching the content. Similarly, products shown, introduced, or advertised on a channel can easily be purchased by the user. If desired, the purchasing history or behaviour of individual or groups of users can be obtained. Users are able to enable or disable this function. A beneficial aspect to this function is that users can receive recommendations of like-minded users based on their purchasing history or pattern. For example, if user A purchases a Jazz music CD by artist B, the purchasing history of other users that also purchased artist B's CD can be used to recommend a similar artist C to user A. Additionally, the purchasing history can be recorded and collected and analyzed to determine appropriate advertising to be delivered to the user.

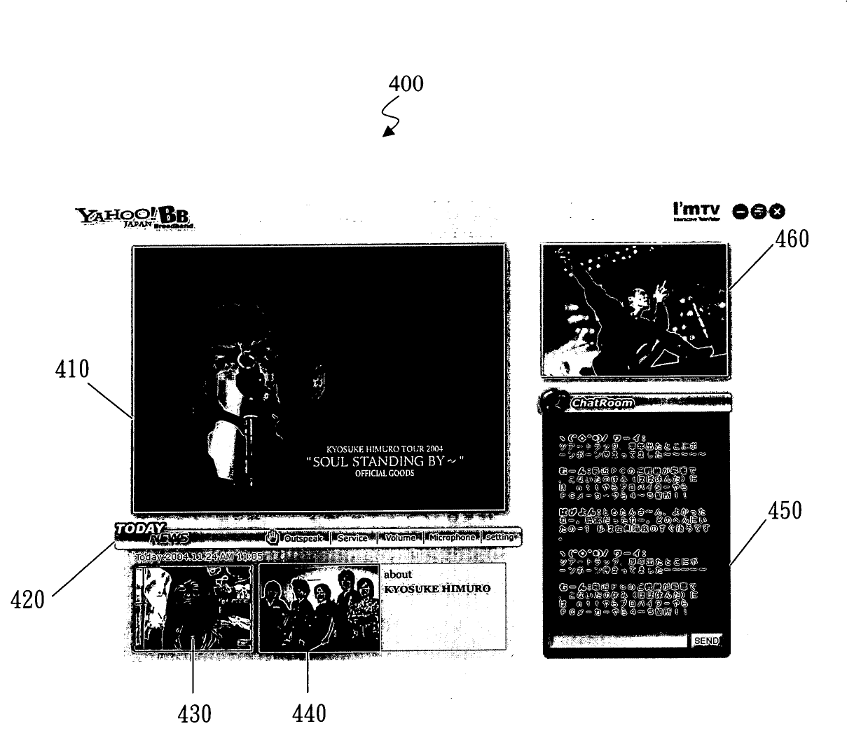

Refer to FIG. 4, which illustrates another application of the intelligent dynamic market data collection system of the present invention. In this embodiment, a live concert is given as an example of application.

As shown in FIG. 4, the interactive multimedia interface 400 comprises an advertising window 410, a first multimedia window 460, a command bar 420, a second multimedia window 430, an information window 440, and a chat room area 450.

In this example, video of the live concert is currently being displayed in the first multimedia window 460. The artist's latest album cover, photos, or other advertising is displayed in the advertising window 410. The second multimedia window 430 displays a host or other member's video. The information window 440 displays information about the artist. Members can text message or chat with other members and the host while the concert is in progress via the chat room area 450. Various commands and setup options can be selected on the command bar 420.

In this way, during the concert various advertising that is pertinent to the content and user can be displayed and available for purchase.

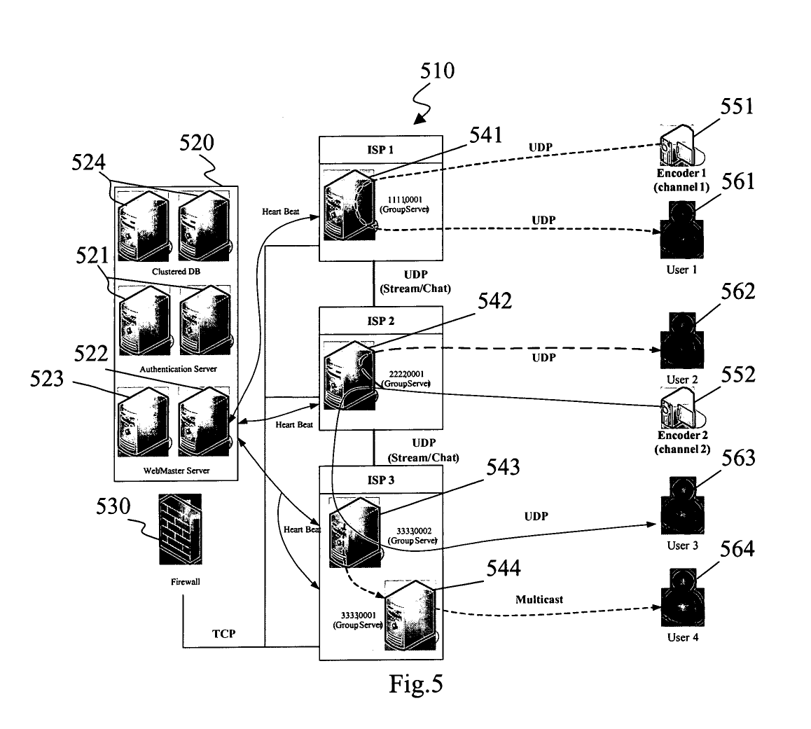

Refer to FIG. 5, which is a diagram illustrating the infrastructure of an interactive multimedia system utilized by the intelligent dynamic market data collection and advertising delivery system according to an embodiment of the present invention.

The infrastructure of the interactive multimedia system 510 utilized by the present invention basically comprises a core server 520 or core servers, a plurality of streaming server 141, 142, 143, 144, and at least one encoder 551, 552. Multimedia content is streamed from the encoder 551 to a user 561 via a streaming server 541. The core servers 520 comprise an authentication server 521, a master server 522, a web server 523, and a database 524. The authentication server 521 is for checking authenticity of users. Users must pass the authenticity check before they can connect to a streaming server. The master server 522 is for redirecting users to a specific streaming server based on the policy defined in the master server 522. The policy determines which server streams the multimedia content to users. The policy can consider an IP range, user information, user account, company name, channel, etc. For example, the policy can be set so that a user's IP indicates the user's location, and an appropriate streaming server located near the user's location can be selected.

The web server 523 provides program information, for example like television program information, to assist users in selecting a channel or program. The program information can list program title, producer, synopsis, time, date, popularity, or other information. The database 524 stores a variety of data such as user information, account information, policies, web information, etc. The core server 520 can comprise a single server or multiple servers. For example, the authentication server 521, master server 522, web server 523, and database 524 can be realized in a single server. Alternatively, each can be a separate server or a combination of servers.

A firewall 530 separates the core servers 520 and the streaming servers 541, 542, 543, 544. This increases the level of protection for the cores servers 520 and reduces the likelihood of attack by hackers.

The streaming servers are a plurality of servers 541, 542, 543, 544 arranged to stream the multimedia content to and from users 561, 562, 563, 564. By adding more streaming servers, the system can be easily scaled to meet the needs of the number of concurrent users. In this way, the load is balanced between the servers and due to the plurality of streaming servers, the servers have high availability. In order to determine which streaming servers 541, 542, 543, 544 are available or on-line, the master server 522 periodically sends heart beat signals to each streaming server 541, 542, 543, 544. The heart beat signals are, for example, TCP packets. This allows the master server 522 to maintain a list of active servers. Therefore, if a streaming server is down or brought off line for maintenance, the master server 522 will redirect users to other streaming servers based on the defined policy and list of active servers.

The encoder or encoders 551, 552 encode the multimedia content. They also make real time streaming possible and provide various bit rates and resolutions. According to the capabilities or environment of the network, channels can be encoded as low as 56 Kbps for dial-up links or up to broadband speed, for example 1.5 Mbps or higher, to provide better quality. Similarly, the resolution can be selected. For example, the resolution can be set to 160×120, 176×144, 320×240, 352×288, 640×480, or higher. Additionally, the frame rate can be adjusted according to the available bandwidth with a higher frame rate requiring more bandwidth. The frame rate can be set to, for example, as low as 1 frame per second or as high as 30 frames per second. Furthermore, the encoders 551, 552 utilize an optimized compression codec that allows real-time or near real-time streaming without the need for buffering. This allows users or broadcasters to interact with the streaming multimedia content in real-time or near real-time.

Transmission control protocol (TCP) is used to connect the core servers 520 and the streaming servers 541, 542, 543, 544. TCP guarantees delivery of data and ensures that packets are delivered in the same order in which they were sent. User datagram protocol (UDP) is used to provide a direct way to send and receive datagrams over the IP network between the encoders 551, 552, streaming servers 541, 542, 543, 544, and users. Multicasting can be utilized to permit sending content to a select group or number of users. For example, streaming server 543 can comprise several servers 543, 544 in order to multicast to users 563 and 564.

As an example of application of the intelligent dynamic market data collection and advertising delivery system, the following scenario is provided. A multimedia producer prepares multimedia content. The multimedia content can be pre-recorded or can be live. A multimedia provider creates or assembles the infrastructure required to distribute the multimedia content. The multimedia producer and the multimedia provider can be the same entity or different entities. The multimedia provider also prepares programming information regarding the multimedia content to assist users in making program or channel selection.

Once the system is established, users can register or sign up for the service. Their user and account information is stored in a database. After the user connects with the multimedia provider and enters their access information, their authenticity is verified. Then the user is able to access the programming information or guide in order to select a channel. When the user has selected the desired channel, the appropriate streaming server is selected and the multimedia content begins streaming to the user. Since the multimedia content is streamed in real-time or near real-time, the user is able to interact with the content. There are numerous ways in which the user can perform this interaction. For example, if the user is connected via the Internet, the user can simply type text into a field in the chat portion of the interface. Depending upon the channel, provider, policy, or producer, the text can automatically show up or can be selectively chosen to show up on the multi-section display. This allows other users to see the sender's comments. In this way, all users of the channel can communicate between each other or with the producer in real-time. Additionally, this allows the content producer to adapt their programming according to user's feedback or discussion. For example, if the multimedia content is a movie, users can may comments or discuss aspects of the movie as it is showing. In another example, if the content is an educational program such as a class on a particular subject, the users can participate in the lecture as students by asking or answering questions.

In addition to text, users are allowed to provide video and audio signals with the addition of a microphone and web camera. In this way, the users can act as partial content producers. Users can also achieve similar results by using a television equipped with a set top box. Alternatively, users can utilize a cellular telephone, for example a 3G handset, to interact. Depending upon the user's equipment the interaction can comprise short message service (SMS) messages, multimedia message service (MMS) messages, still photographs, video, and audio. Furthermore, users can enjoy the audio portion of the multimedia content and interact audibly with the content by using a traditional telephone.

During the interactive multimedia session, various data is stored such as the user's user history, voting history, viewing history, scheduling history, rating history, purchasing history, current web page, web history, current program identification, account information, or a combination of these are stored, collected, and analyzed. After analysing, the system of the present invention sends appropriate advertising based on this various data to appropriate users. The data collection, analysing, and advertising delivery can be realized automatically, dynamically, or scheduled periodically.

Obviously, many variations can be made to the above example. For example, the content, number of users, providers, content location, etc. can be changed or adapted according to requirements.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An intelligent dynamic marketing collection and delivery system comprising:
collecting a user's data;
analyzing the data to determine appropriate advertising for the user; and
delivering the appropriate advertising to the user.

2. The intelligent dynamic marketing collection and delivery system of claim 1, wherein the user's data comprises an internet protocol number.

3. The intelligent dynamic marketing collection and delivery system of claim 2, wherein:
the internet protocol number indicates the user's location; and
the appropriate advertising is advertising targeted at users in an internet protocol range.

4. The intelligent dynamic marketing collection and delivery system of claim 1, wherein the user's data comprises user history, voting history, viewing history, scheduling history, rating history, purchasing history, current web page, web history, current program identification, account information, or a combination of these.

5. The intelligent dynamic marketing collection and delivery system of claim 4, wherein the user's account information comprises gender, age, location, job title, hobbies, interests, name, or a combination of these.

6. The intelligent dynamic marketing collection and delivery system of claim 1, wherein requirements for determining appropriate advertising are stored in a database.

7. The intelligent dynamic marketing collection and delivery system of claim 1, wherein the appropriate advertising is updated dynamically, automatically, or periodically.

8. The intelligent dynamic marketing collection and delivery system of claim 1, wherein the data is collected dynamically, automatically, or periodically.

9. An intelligent dynamic marketing collection and delivery system comprising:
obtaining a user's internet protocol number;
analyzing the internet protocol number to determine an internet protocol range that the internet protocol number falls into; and
delivering appropriate advertising according to the internet protocol number range to the user.

10. The intelligent dynamic marketing collection and delivery system of claim 9, wherein the user's internet protocol number indicates the user's location.

11. The intelligent dynamic marketing collection and delivery system of claim 9, further comprising:
collecting user data comprising user history, voting history, viewing history, scheduling history, rating history, purchasing history, current web page, web history, current program identification, account information, or a combination of these;
analyzing the collected data; and
delivering appropriate advertising based on the collected data.

12. The intelligent dynamic marketing collection and delivery system of claim 11, wherein the user's account information comprises gender, age, location, job title, hobbies, interests, name, or a combination of these.

13. The intelligent dynamic marketing collection and delivery system of claim 9, wherein requirements for determining appropriate advertising are stored in a database.

14. The intelligent dynamic marketing collection and delivery system of claim 9, wherein the appropriate advertising is updated dynamically, automatically, or periodically.

15. The intelligent dynamic marketing collection and delivery system of claim 9, wherein the data is collected dynamically, automatically, or periodically.

16. An intelligent dynamic marketing collection and delivery system comprising:
obtaining an internet protocol number of a user;
obtaining the user's history;
obtaining the user's voting history;
obtaining the user's viewing history;
obtaining the user's scheduling history;
obtaining the user's rating history;
obtaining the user's purchasing history;
obtaining the user's web browsing history;
obtaining a current program identification;
obtaining the user's account information;
analyzing the obtained data to determine appropriate advertising; and
delivering the appropriate advertising to the user.

17. The intelligent dynamic marketing collection and delivery system of claim 16, wherein:
the internet protocol number indicates the user's location; and
the appropriate advertising is advertising targeted at users in an internet protocol range.

18. The intelligent dynamic marketing collection and delivery system of claim 16, wherein the user's account information comprises gender, age, location, job title, hobbies, interests, name, or a combination of these.

19. The intelligent dynamic marketing collection and delivery system of claim 16, wherein the appropriate advertising is updated dynamically, automatically, or periodically.

20. The intelligent dynamic marketing collection and delivery system of claim 16, wherein the data is collected dynamically, automatically, or periodically.
